(19) United States
(12) Patent Application Publication
(10) Pub. No.: US 2010/0230018 A1
(43) Pub. Date: Sep. 16, 2010

(54) THEFT DETERRENT ANTI-SCANNING DEVICE

(76) Inventor: Cynthia A. Nielsen, Commerce, MI (US)

Correspondence Address: CARGILL & ASSOCIATES, P.L.L.C., 56 MACOMB PLACE, MT. CLEMENS, MI, 48043, US

(21) Appl. No.: 12/724,221

(22) Filed: Mar. 15, 2010

Related U.S. Application Data
(60) Provisional application No. 61/160,196, filed on Mar. 13, 2009.

(51) Int. Cl. A45C 13/18; B32B 1/04; B32B 33/00; G01S 19/14; G01S 19/35

(52) U.S. Cl. 150/102; 428/76; 428/35.3; 428/74; 342/357.52; 342/357.75

(57) ABSTRACT

A theft deterrent anti-scanning device incorporating a metallic anti-scanning and shielding layer laminated into various articles to encapsulate cards and financial documents which carry sensitive personal financial information that can be read by traditional RIFD scanning devices. However, if you incorporate a Faraday cage to block RF frequencies up to 2.4 gigahertz, the card must be entirely encapsulated for the RF shielding to be effective. A GPS tracking device may be added in order to retrieve lost or stolen information, and the entire device may be configured to become portion of a purse or an enclosable pouch. In other aspects of the present invention, an enclosable pouch of description in the application may render the pouch to be water proof, fire resistant, and to be protected from theft.

### CROSS REFERENCES TO RELATED APPLICATIONS

This application claims the benefit under 35 U.S.C. 119(e) of U.S. Provisional Application No. 61/160,196 filed on Mar. 13, 2009.

### TECHNICAL FIELD OF THE INVENTION

This invention relates to anti-scanning devices, and more particularly to a wallet or purse contained anti-scanning foil device.

### BACKGROUND OF THE INVENTION

Recently, with the advent of radio-frequency tags making purchases as easy as waving your hand containing the credit card, there has been a proliferation of thieves with scanners that can steal personal data right through your back pocket. People desiring more privacy are also inclined to want to shield their information so that advertisers and shopkeepers cannot tap into your information when you enter their stores.

This new trend is a “contactless credit card”. Such a card can be merely waved by a scanner in order to charge your account. In the past few years, gas stations have had the wand, and the new “pay as you go” concept is advertised extensively as a way to more quickly finalize transactions. However, the “contactless” credit cards wirelessly communicate information about the consumer and his credit card account numbers. In essence, they do not have an “off switch”, making them susceptible to a thief with a scanner walking past you and receiving all your credit card information just by holding the scanner in close proximity to your back pocket.

Radio-frequency-identification “RFID” technology is used in these contactless “smart” credit cards to speed retail transactions. Generally, no signature is required as the credit card is merely waved or passed in front of a scanner and the customer is allowed to go. The earliest example of this technology was the Mobile gas station Speedpass, and now Mastercard, Visa, and American Express have begun issuing contactless cards for their customers. Dollar bills have RIFD lines incorporated into the paper, so upon entering a store, with a scanner, the store employees can know how much money you have in your pocket or purse, as well as all your credit card information. Although these card issuers assure the safety and encryption of these transactions, there have been studies done by graduate students at universities that have been able to hack the Speedpass or remove unencrypted names, account numbers, and expiration dates off of contactless credit cards using a variety of homemade scanning devices. One of the tests shown on the “Today Show” illustrated the capturing of data when the scanner was placed in a briefcase and “read” the appropriate account information from a contactless credit card in another person's back pocket. The RFID radio-frequency tags are always open to wireless access whether you are using them or not, so anyone with the necessary scanning equipment can read the data. Further, this necessary equipment is getting less expensive and more sophisticated all the time.

To show how prevalent this wireless access RFID technology has been recently, we look to the government and student identification badges, electronic passes that allow drivers to speed pass tollbooths on toll-ways, plastic tags on clothes that discourage shoplifting, ID tags that are embedded under pets skin, and these RFID chips are used to track inventory in retail locations as well as seaports for tracking shipping containers.

Therefore, it would be an advantage to provide a device to prevent the scanning of data unknowingly from a consumer.

### SUMMARY OF THE INVENTION

Securing private data that is RIFD enabled into credit cards and smart cards has been the subject of prior inventions, although problems arose because they did not completely shield the data from anyone wishing to access it. In accordance with the present invention, those problems are solved by providing a completely enclosing metallic shield which is preferably laminated with a flexible plastic to provide a protective coating for the metal shield. The metal foil laminated is thought to provide a Faraday cage to prevent anyone from reading the information that is stored on credit cards or smart cards.

The present invention may be thought of as providing an “off” switch to prevent communication of information about someone or his account that is stored on the credit card or smart card that he may be handling.

In addition to providing security for radio frequency identification information accessibility to parties that one might not want to have access, the enclosing laminated structure may be incorporated into an enclosable pouch to provide a waterproof environment, and may further include a fireproof material in its laminated plastic and/or a GPS tracking device in order to be able to retrieve the RIFD shielding device, as it is enclosing the cards including the RIFD information.

Another aspect of the present invention includes a much more complete protection for the cards besides being waterproof, fire resistant, thief-retrievable and doing all of this while being a RIFD shield from third parties. Such construction should effectively prevent RIFD emission in order to provide complete protection to the owner of the information that is desired to be kept private.

Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein;

FIG. 1 is a theft deterrent anti-scanning device made in accordance with the present invention;

FIG. 2 is a cross sectional view of the laminated structure of the anti-scanning device of FIG. 1;

FIG. 3 is another embodiment of the theft deterrent anti-scanning device;

FIG. 4 is a front elevational view of a handbag including therein a theft deterrent anti-scanning device;

FIG. 5 is yet another aspect of the anti-scanning device including an enclosable pouch with a waterproof seal;

FIG. 6 is an envelope type pouch incorporating the anti-scanning device;

FIG. 7 illustrates an enclosable pouch with a hook attached thereto; and

FIG. 8 illustrates a anti-scanning device further incorporating a GPS as shown in a cutaway view.

### DETAILED DESCRIPTION OF THE INVENTION

In accordance with the present invention, disclosed is a theft deterrent anti-scanning device useful for wallets, purses, and other applications when it is desirable to prevent scanning of private information without a consumer's knowledge. In its most basic form, the present invention provides a laminated anti-screening device, sturdy enough to withstand daily use in a wallet or purse or car visor, and one which can be enclosed sufficiently around credit cards so as to prevent the use of a scanner from picking up the magnetic information that's on the contactless card. If a card has an anti-scanning device wrapped around it, while leaving loose even some of the anti-scanning device is loose around the card, the card can still be read.

It is, therefore, one aspect of the present invention to provide a sufficiently enclosed anti-scanning device or pouch for receiving the contactless cards so that there are no open edges allowing a scanner to read the information even though the anti-scanning device may be partially in place.

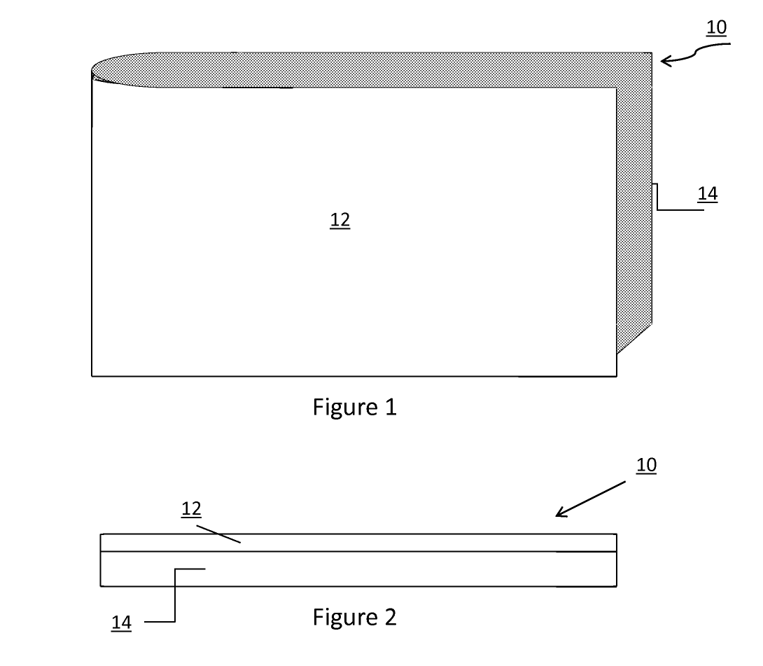

FIG. 1 illustrates the anti-scanning device in its most basic form, wherein the anti-scanning material is a sheet 10 of scan resistant materials, generally including metals foils, which may be selected from the group consisting of aluminum, cobalt-containing metals, or any other suitable RFID reflecting metal or metal composite, and molybdenum oxide, Mylar, tin, or an RFID anti-scanning polymeric material, or combinations thereof. A wear resistant exterior coating or layer 12 shields from daily use the anti-scanning foil 14 contained therein. Such an exterior coating may include plastic, Mylar, organic materials, leather, fibrous, fabric such as silk, cotton, polyester, nylon, or the like, a non-woven polyester material, or any other suitable material that would withstand the rigors of everyday use in a wallet, pocket or purse. Other possibilities include materials for the plastic laminate where it is made of a material selected from the group consisting of polyester, nylon, tyvek, polyethylene, polyurethane, and combinations thereof.

FIG. 1 illustrates a configuration suitable for use in a wallet or purse, as well as the use of an anti-scanning device for a car visor, in the utilization of toll road booths and other fast access entry ports. The anti-scanning device is folded to cover any RFID devices that are meant to be shielded within.

FIG. 2 is a side elevation view of a portion of the anti-screening device of FIG. 1, showing the relative placement of the exterior coating 12 with respect to the anti-scanning layer 14.

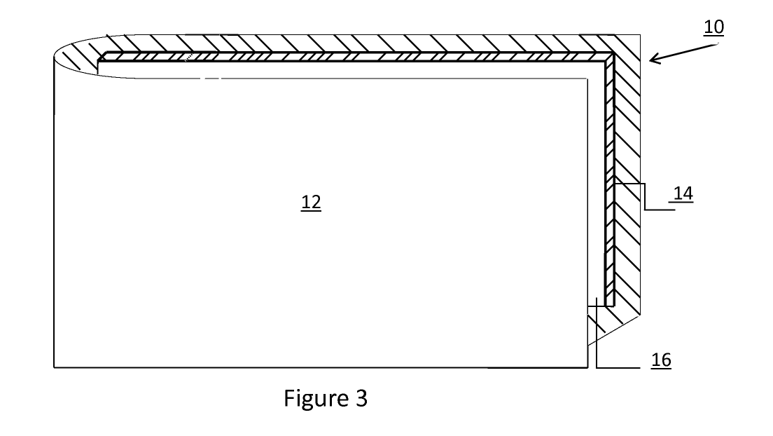

Looking next to FIG. 3, there is shown a credit card 16 in proper placement within the anti-scanning device 10 and enveloped by the anti-scanning device 14.

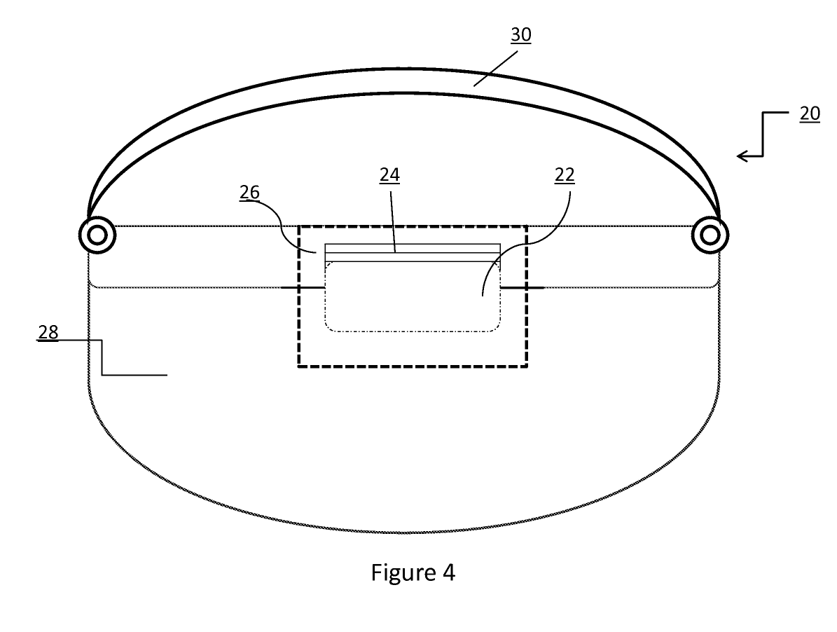

FIG. 4 illustrates yet another aspect of the present invention including an anti-scanning device pouch to be adhered inside a purse 20. The pouch 22 may further include credit card compartments 24 which are sewn into the side pocket 26 within the body 28 of purse 20. Purse handle 30 illustrates the relative placement. In this aspect of the present invention, enclosing the contactless credit cards within pouch 22 yields a situation where a scanner is severely inhibited from reading information from the cards, because they are enclosed within the slots 24, meaning that there are no loose edges where the scanner could read the magnetic strip.

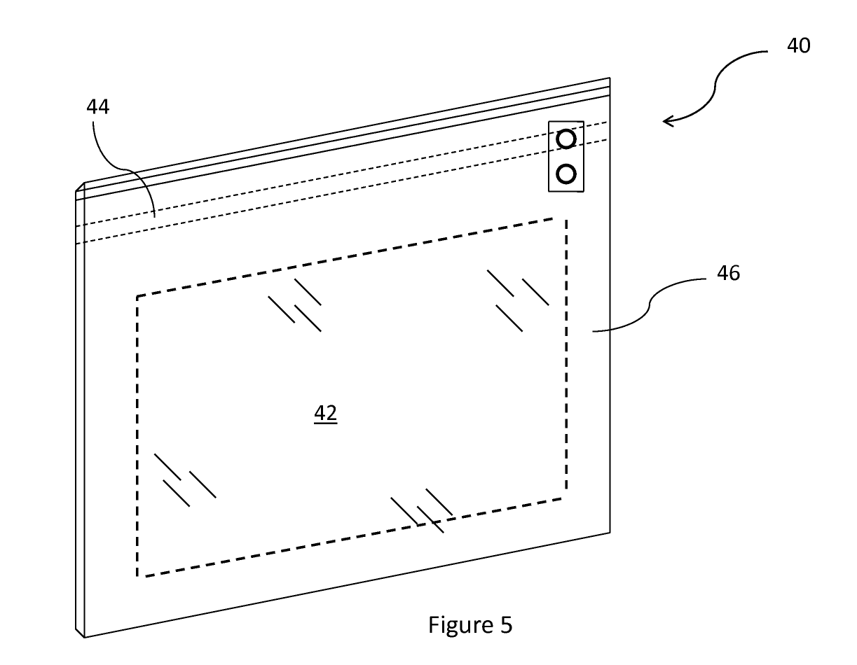

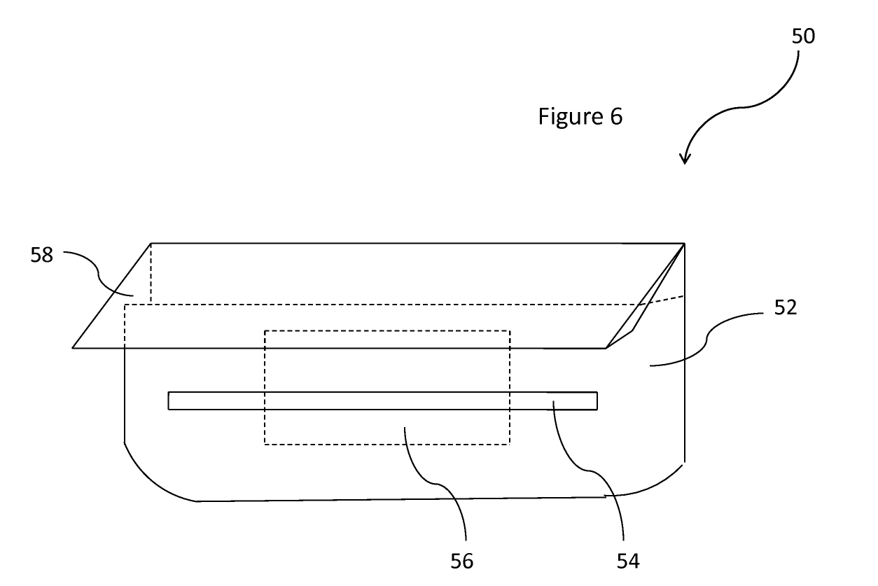

FIG. 5 is still one more aspect of the present invention which discloses a completely enclosable pouch with a water proof seal at the top. FIG. 5 is made of a similar construction as to the anti-scanning layer material disclosed in FIGS. 1 through 3, although it is constructed into an enclosable pouch which may also keep documents in a waterproof condition. For waterproof ability, the material selected would be waterproof, such as plastic laminated tin foil or aluminum foil, or any other suitable waterproof material that can be constructed into this pouch configuration with a zip-lock type re-closable fastener at the top. The pouch is generally denoted by 40, and is designed to encapsulate credit cards or other RFID tagged devices 42 within the pouch exterior layers 46. Re-closeable, waterproof sealer 44 is shown at the top of pouch 40 in order to maintain a water-free barrier to safeguard the credit cards 42. Furthermore, the exterior layers 46 may be made of a material that is also fireproof, or may further include their own tracking devices or decoy RFID signal transmitters to throw off the thieves by signaling an improper credit code or RFID. Such tracking devices are described in the appending publications and are off-the-shelf units commercially available from the sources shown hereinafter.

Looking next to FIG. 6, there is shown an envelope type pouch generally denoted by the numeral 50, including a front piece 52 with a fastener 54 adhered thereon. After the RFID-containing device 56, such as a credit card or currency bills, has been inserted into the envelope, the envelope flap 58 is folded down over the front flap 52 and secured to fastener 54, thereby essentially creating a sealable Faraday cage which would be helpful to shield “pinging” by a thief armed with a scanner receiver from stealing your identity from very far away. Naturally, this aspect of the common invention can be incorporated into a handbag, or may be a simple carrying device for important papers, or may be used as a separate wallet to be placed within a purse or briefcase.

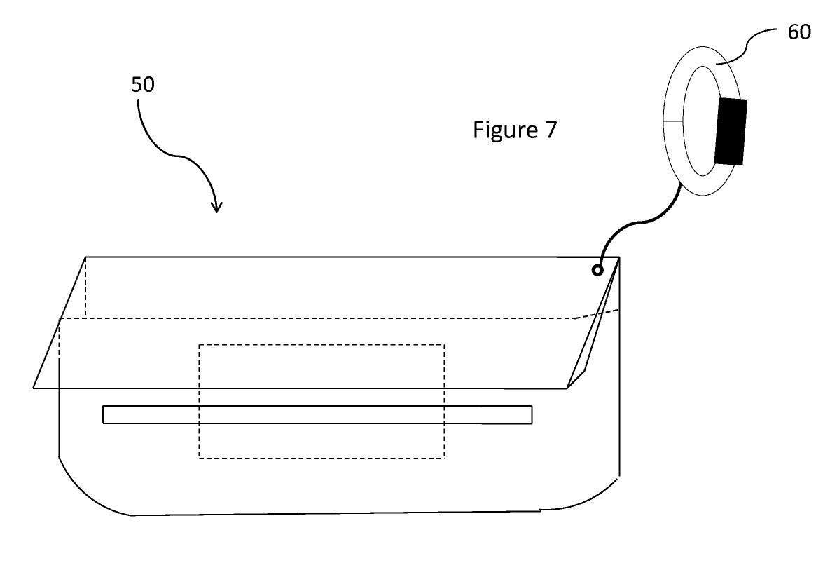

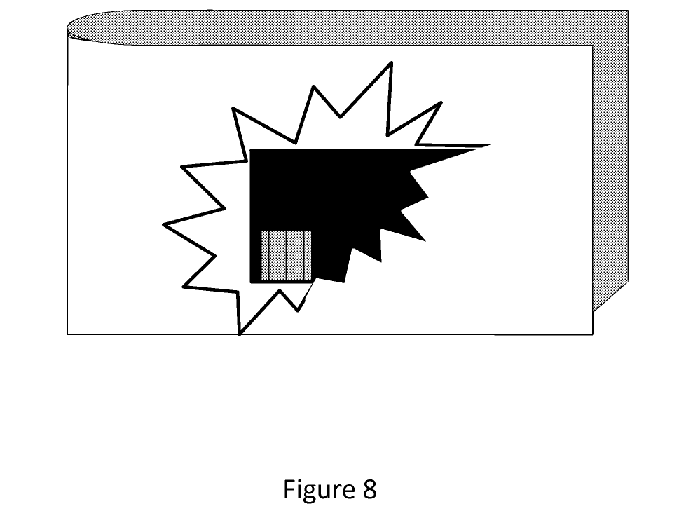

Now we look at FIG. 7, which includes an enclosable pouch as the one shown in FIG. 6, although it further includes the use of a clip 60 which may be any type of hook, including the use of a carbineer, shackle, clevis, or any other suitable type of hook for snapping into a handbag or briefcase to assure that it is not able to be removed by a pickpocket.

Looking lastly to FIG. 8, there is shown the theft deterrent anti-scanning device made in accordance with the present invention that further includes a real time GPS tracking device incorporated into the laminated structure as shown in FIG. 1 and FIG. 2. Incorporating a GPS tracking device into the laminated structure means that if the entire pack of identification materials is lost or stolen, it can be retrieved via GPS, thereby providing even more assurances to the owner of the protected package that their information will not be lost or stolen. In this aspect of the present invention, it is most desirable to incorporate an ultra slim GPS unit, especially an ultra slim real-time GPS tracking device so that it is adapted easily into the anti-scanning device in the present invention.

One such device that is commercially available may be purchased from Catseye Mk2 or the CATS.i which has an integrated GPS chip set and support for quad-band GSM/GPRS cellular networks. This device is available from Catseye Corporation from London, England. This device looks somewhat like a cell phone battery, as it is approximately 5 millimeters thick, allowing for more applications of the device on portable devices, such as backpacks and clothing. The Catseye device is guaranteed to be completely waterproof from the manufacturer and can be capable of being laminated within the polyester laminate of the present anti-scanning device. Another possible source of such a GPS device is one that is commercially available at best buy stores for $99.00 called the “Little Buddy Child Tracker”.

According to their advertisements, the “Little Buddy” website allows you to register the tracker with your email address and a password. Once you have become registered and logged in, a visit to the website will allow you to find out exactly where your identification device with the anti-scanning device is located. This will allow retrieval if the identification package that is being protected with the anti-scanning device of the present invention is either lost or stolen. Of course, any other commercially available GPS tracking system and/or device will be suitable for this purpose.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated.

What is claimed is:

1. An anti-scanning device, comprising:
a metallic anti-scanning and shielding layer;
a flexible plastic laminate material laminated over the shielding layer; and
a waterproof material encompassing the entire device.

2. The anti-scanning device of claim 1, further comprising a watertight zip-loc type closure device, whereby an enclosable pouch is formed from the laminated shielding layer with waterproof material encompassing the entire device, so that the pouch is water-tight.

3. The anti-scanning device of claim 1, further comprising a fire-proof material incorporated into the laminate material, such that the anti-scanning device will be fire- proof.

4. The anti-scanning device of claim 1, further comprising a GPS tracking device incorporated into the laminate material, so that if the device is lost or stolen, it can be tracked and retrieved.

5. The anti-scanning device of claim 1, wherein the plastic laminate is made of a material selected from the group consisting of polyester, nylon, tyvek, polyethylene, polyurethane, and combinations thereof.

6. The anti-scanning device of claim 1, further comprising a material layer of a material selected from the group consisting of Mylar, organic materials, leather, fibrous, fabric such as silk, cotton, polyester, nylon, or the like, a non-woven polyester material, and combinations thereof, including any other suitable material.

7. The anti-scanning device of claim 1, wherein the metallic anti-scanning and shielding layer is made of a material consisting of a metallic foil selected from the group consisting of aluminum, cobalt-containing metals, other suitable RFID reflecting metals, metal composites, molybdenum oxide, Mylar, tin, RFID anti-scanning polymeric material, and combinations thereof.

8. The anti-scanning device of claim 1, wherein the device may further include credit card compartments, which are sewn into a side pocket within the body of purse.

9. The anti-scanning device of claim 1, wherein the device may further include a purse pocket being made of the anti-scanning device itself.

10. The anti-scanning device of claim 1, wherein the device may be an envelope type pouch including a front piece with a fastener adhered thereon to form a completely enclosing envelope adapted for receiving credit cards or other RFID-containing documents, such that it is impossible for the RFID information to be read through the full envelope of anti-scanning device material.
